(19) United States
(12) Patent Application Publication
(10) Pub. No.: US 2008/0150816 A1
(43) Pub. Date: Jun. 26, 2008

(54) Antenna feed arrangement

(75) Inventors: Jussi Rahola, Espoo (FI); Jani Ollikainen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/645,117

(22) Filed: Dec. 21, 2006

(51) Int. Cl. H01Q 1/00; H01Q 1/50

(52) U.S. Cl. 343/720; 343/859

(57) ABSTRACT

The specification and drawings present a new apparatus and method for antenna arrangement by providing a feed arrangement through a flex connection for radiating elements of a first part and a second part (e.g., lower and upper parts, respectively) of a mobile terminal (e.g., a slide-type terminal), wherein the first and second parts are configured to move relative to each other during operation of the mobile terminal. For a slide-type terminal, the first and the second parts can be sliding relative to each other during said operation. This antenna arrangement can be used by any of the cellular or non-cellular wireless systems.

### FIELD OF THE INVENTION

This invention generally relates to wireless communications and more specifically to antenna feed arrangement in mobile terminals, e.g., slide-type terminals.

### BACKGROUND ART

Antennas are critical elements in mobile products and their number is increasing with required wireless access systems in one wireless product using a small space. Current mobile terminals have to support multiple cellular radio systems, such as GSM (global system for mobile communications), WCDMA (wideband code division multiple access), CDMA (wideband code division multiple access), CDMA2000, etc., and non-cellular radio systems, such as WLAN (wireless local area network), BLUETOOTH, GPS (global positioning system), DVB-H (digital video broadcasting—handheld), etc. The design of antennas for all these frequency bands is a challenging task because there is a limited amount of space available for the antennas.

### DISCLOSURE OF THE INVENTION

According to a first aspect of the invention, an apparatus, comprises: a first part comprising a radiating element; a second part comprising a further radiating element, wherein the first and second parts are configured to move relative to each other during operation; and at least one connecting flex, for providing a flexible connection between the first and second parts, for providing a radio frequency signal between the radiating element and the further radiating element during the operation.

According further to the first aspect of the invention, the first and second parts may be configured to slide relative to each other during the operation.

Still further according to the first aspect of the invention, the radiating element and the further radiating element may be printed wiring boards or flexible wiring boards.

According further to the first aspect of the invention, the apparatus may comprise at least one more connecting flex for providing a direct current power between the second and first parts.

According still further to the first aspect of the invention, the first part or the second part may be combined with the at least one connecting flex as one part and the one part may be made from a plastic flexible material.

According still further to the first aspect of the invention, the at least one connecting flex may be made of a plastic flexible material and may comprise at least one flexible electrically conducting strip. Further, the radio frequency signal may be provided to the radiating element or to the further radiating element through the at least one flexible electrically conducting strip, wherein a feed arrangement for the radio frequency signal may be provided to the at least one flexible electrically conducting strip using a feed pad on the first or second part. Further still, the radio frequency signal may be provided to the radiating element or to the further radiating element through the at least one flexible electrically conducting strip using a direct electrical connection between the at least one flexible electrically conducting strip and a printed wiring board of the first part or a further printed wiring board of the second part, respectively, but without connecting the at least one flexible electrically conducting strip to an RF ground of the printed wiring board or the further printed wiring board, respectively. Still further, the at least one flexible electrically conducting strip may be made of copper.

According yet further still to the first aspect of the invention, the at least one connecting flex or at least one further connecting flex may be configured for providing between the second and first parts at least one of: a) a connection for a direct current power, b) a connection for grounding or short circuiting, and c) a connection for a further electrical signal. Further, the connection for the grounding or short circuiting may comprise discrete components.

Yet still further according to the first aspect of the invention, the radio frequency signal may be provided to the radiating element or to the further radiating element through at least one flexible electrically conducting strip of the at least one connecting flex, wherein a feed arrangement for the radio frequency signal to the at least one flexible electrically conducting strip may be provided on the first or second part using one of: a) galvanic feeding, b) capacitive feeding, and c) inductive feeding. Further, the feed arrangement may comprise a matching circuit. Still further, the feed arrangement may comprise a balun.

Still yet further according to the first aspect of the invention, the apparatus may be for wireless communications in cellular or non-cellular systems.

Still further still according to the first aspect of the invention, the apparatus may be part of or implemented as a mobile terminal, a portable communication device, a wireless device, a mobile communication device, a mobile phone or a mobile device for wireless communications in cellular or non-cellular systems.

According to a second aspect of the invention, a method, comprises: providing a flexible connection between a first part and a second part of an electronic device, wherein the first part comprises a radiating element and the second part comprises a further radiating element, and the first part and the second part are configured to move relative to each other during operation of the electronic device; and providing a radio frequency signal between the radiating element and the further radiating element during the operation.

According further to the second aspect of the invention, the first and second parts may be configured to slide relative to each other during the operation.

Further according to the second aspect of the invention, the radiating element and the further radiating element may be printed wiring boards or flexible wiring boards.

Still further according to the second aspect of the invention, the method may comprise at least one more connecting flex for providing a direct current power between the second and first parts.

According further to the second aspect of the invention, the first part or the second part may be combined with the at least one connecting flex as one part and the one part may be made from a plastic flexible material. Further, the at least one connecting flex may be made of a plastic flexible material and may comprise at least one flexible electrically conducting strip. Still further, the radio frequency signal may be provided to the radiating element or to the further radiating element through the at least one flexible electrically conducting strip, wherein a feed arrangement for the radio frequency signal is provided to the at least one flexible electrically conducting strip using a feed pad on the first or second part. Yet still further, the radio frequency signal may be provided to the radiating element or to the further radiating element through the at least one flexible electrically conducting strip using a direct electrical connection between the at least one flexible electrically conducting strip and a printed wiring board of the first part or a further printed wiring board of the second part, respectively, but without connecting the at least one flexible electrically conducting strip to an RF ground of the printed wiring board or the further printed wiring board, respectively. Further still, the at least one flexible electrically conducting strip may be made of copper.

According still further to the second aspect of the invention, the electronic device may be a mobile terminal, a portable communication device, a wireless device, a mobile communication device, a mobile phone or a mobile device for wireless communications in cellular or non-cellular systems.

According to a third aspect of the invention, an apparatus, comprises: a first part comprising a radiating element; a second part comprising a further radiating element, wherein the first and second parts are configured to move relative to each other during operation; and at least one connecting means, for providing a flexible connection between the first and second parts, for providing a radio frequency signal between the radiating element and the further radiating element during the operation.

Further according to the third aspect of the invention, the at least one connecting means may be at least one connecting flex made from a plastic flexible material.

### BRIEF DESCRIPTION OF THE DRAWINGS

For a better understanding of the nature and objects of the present invention, reference is made to the following detailed description taken in conjunction with the following drawings, in which:

FIG. 1 is a schematic representation of a slide-type mobile terminal comprising first (lower) and second (upper) parts with at least one connecting flex for providing a radio frequency signal between the radiating elements of the first (lower) and the second (upper) parts, according to an embodiment of the present invention.

FIGS. 2a and 2b are schematic representations of a wide connecting flex (top and side view respectively), according to an embodiment of the present invention.

FIGS. 3a and 3b are schematic representations of a feed arrangement in the first (lower) part of the mobile terminal in a closed position (FIG. 3a) and in an open position (FIG. 3b) of a slide-type mobile terminal, according to an embodiment of the present invention;

FIG. 4 is a schematic representation of a feed arrangement in the first (lower) part of the mobile terminal using a feed pad with a stripline, according to an embodiment of the present invention.

FIGS. 5a-5e are schematic representations of different feed arrangements in the first (lower) part of the mobile terminal, according to various embodiments of the present invention.

FIG. 6 is a schematic representation of a matching circuit for a feed arrangement in the first (lower) part of the mobile terminal, according to an embodiment of the present invention.

FIG. 7 is a flow chart illustrating application of the slide-type mobile terminal comprising at least one connecting flex between lower and upper parts, according to an embodiment of the present invention.

### MODES FOR CARRYING OUT THE INVENTION

A new apparatus and method are presented for antenna arrangement by providing a feed arrangement through a flex connection for radiating elements of a first part and a second part (e.g., lower and upper parts, respectively) of a mobile terminal (e.g., a slide-type terminal), wherein the first and second parts are configured to move relative to each other during operation of the mobile terminal, according to an embodiment of the present invention. For a slide-type terminal, the first and the second parts can be sliding relative to each other during said operation. This antenna arrangement can be used by any of the cellular or non-cellular wireless systems. The mobile terminal can be (but is not limited to); an electronic device, a portable communication device, a wireless device, a mobile communication device, a mobile phone, a mobile device, etc.

Thus, according to various embodiments described herein, a radio frequency (RF) signal feed arrangement is used in such a way that the two parts of the mobile terminal are being driven against each other (instead of driving the antenna element against the ground plane). The two parts of the mobile terminal together are considered to be the antenna which is equivalent to feeding the two arms of a dipole antenna against each other.

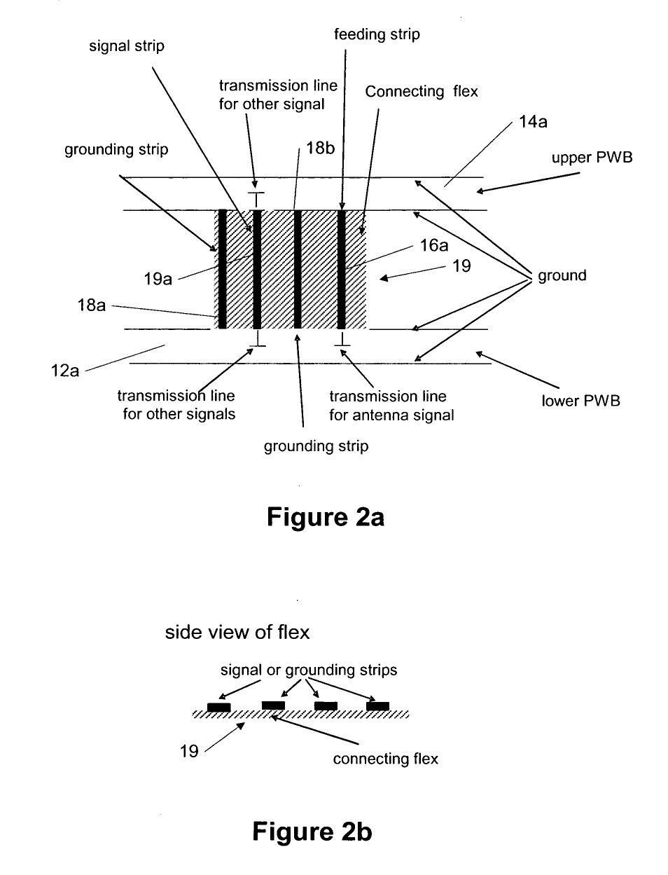

According to an embodiment of the present invention, the mobile terminal can comprise at least one connecting flex, for providing a flexible connection between said first and second parts and for providing a radio frequency signal between the radiating elements of the first and second parts during said operation. According to a further embodiment, the radiating element and the further radiating elements can be ground planes or generally printed wiring boards (PWBs) or flexible wiring boards comprising said ground planes and any metal parts attached to these. The radiating element and the further radiating elements can also be parts or sections of the PWB or flexible ground planes or any metal parts attached to these. In addition, the radiating element and the further radiating elements can be essentially asymmetric. The at least one connecting flex can be made of a plastic flexible material and can comprise at least one flexible electrically conducting strip. For example, this connecting flex can be made of multiple layers of thin flexible plastic (such as polyimide) between which there are thin flexible conducting strips (e.g., made of copper). Alternatively, the connection can be made with a flexible electrically conducting wire. The flexible conducting strips (e.g., copper lines) can be used to convey signals and power between the first and second parts. The mobile device can comprise at least one more connecting flex providing, for example, short circuiting or grounding between the first and the second parts (e.g., between the radiating elements or ground planes of the first and second parts) for providing a direct current (DC) power between the second and first parts. The shorting or grounding connection might have some discrete components to modify the coupling between the radiating elements of the upper and lower parts. As shown in FIGS. 2a and 2b, from the antenna point of view the shorting connection can modify the antenna input impedance. The input impedance can further be modified using the discrete components mentioned above.

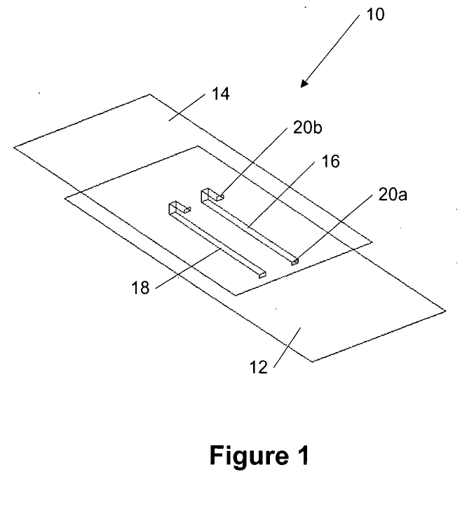

FIG. 1 is an example among others showing a schematic representation of a slide-type mobile terminal 10 (e.g., an electronic device, a mobile device or a mobile phone) comprising lower and upper parts with at least one connecting flex for providing a radio frequency (RF) signal between/to the radiating elements of the first (lower) and the second (upper) parts 12 and 14, respectively, according to an embodiment of the present invention. Here, the connecting flex 16 can provide said RF signal between/to the radiating elements through connections 20a and 20b respectively (see FIGS. 2a and 2b, 3a and 3b, 4, and 5a-5e for more detail). The antenna arrangement, according to one embodiment, can be implemented using only one connecting flex 16 if the battery power is needed only in one part (the first or the second part 12 or 14) or if the battery power can be delivered to both parts without grounding the two parts together. Otherwise, the connecting flex 18 can be used for providing a DC power between the second and first parts, as described herein. Alternatively, according to another embodiment, as shown in an example of FIGS. 2a and 2b, a single wide connecting flex 19 could be used such that a portion of the flex width can be used for grounding (e.g., using strips 18a and 18b), and providing DC power and other electrical signals (e.g., using strip 19a) between the two parts of the terminal and a narrow part of the connecting flex 19 can be used for providing the RF antenna signal (e.g., using strip 16a) to the radiating elements, e.g., printed wiring boards (PWBs) 12a and 14a of the parts 12 and 14, respectively.

It is further noted that alternatively, according to an embodiment of the present invention, one radiating element (e.g., the printed wiring board) of the first or the second part 12 or 14 can be made of the flex material and combined with the connecting flex 16 as one part, wherein said one part is made from a plastic flexible material such that the connection 20a is not needed. In this case, the RF connection to the part 14 is already in place.

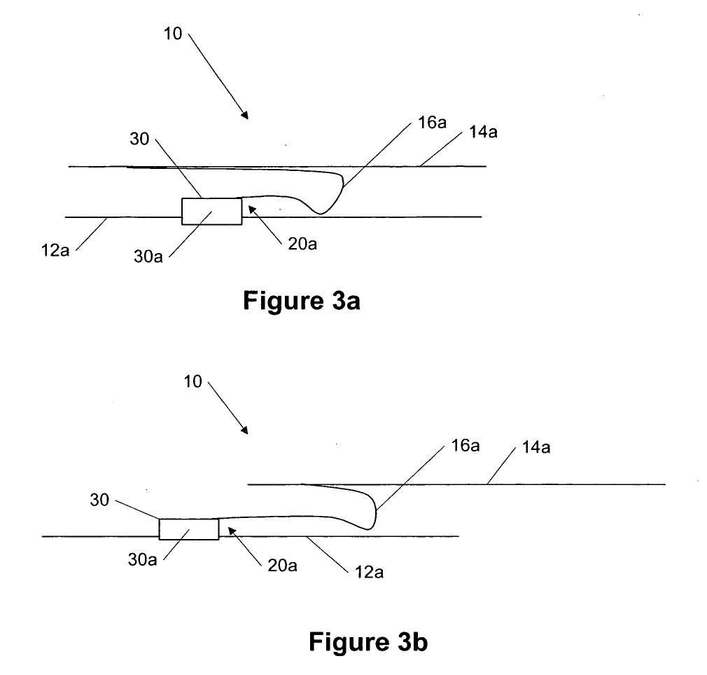

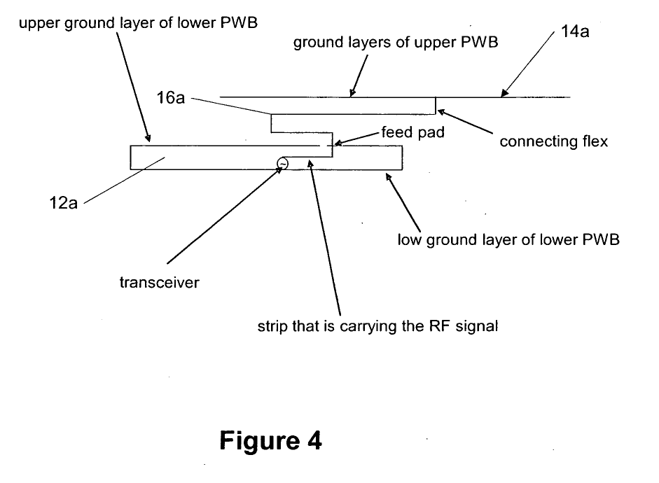

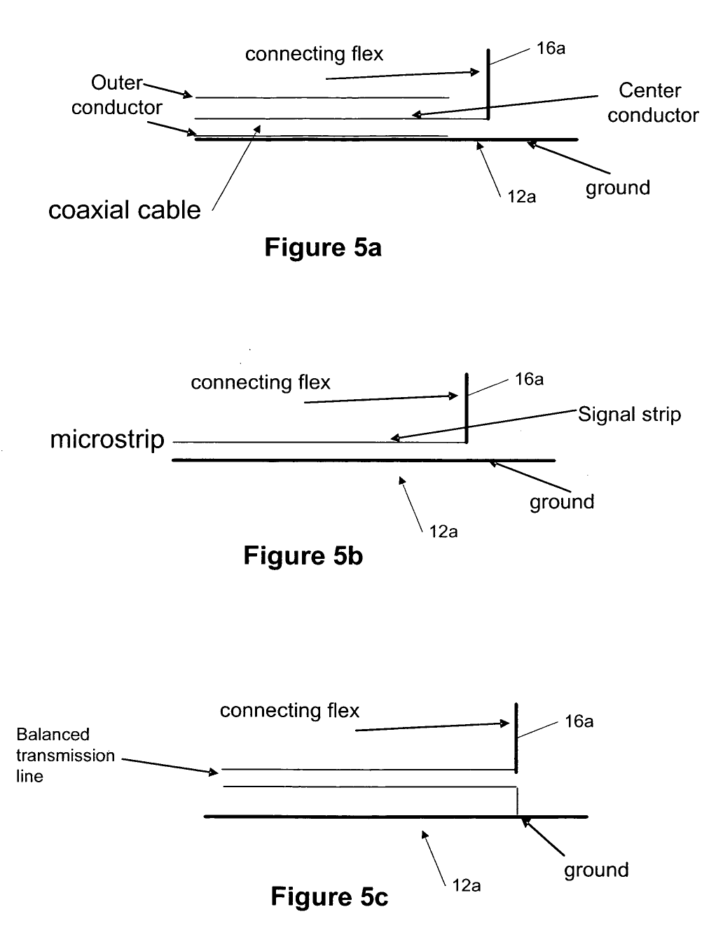

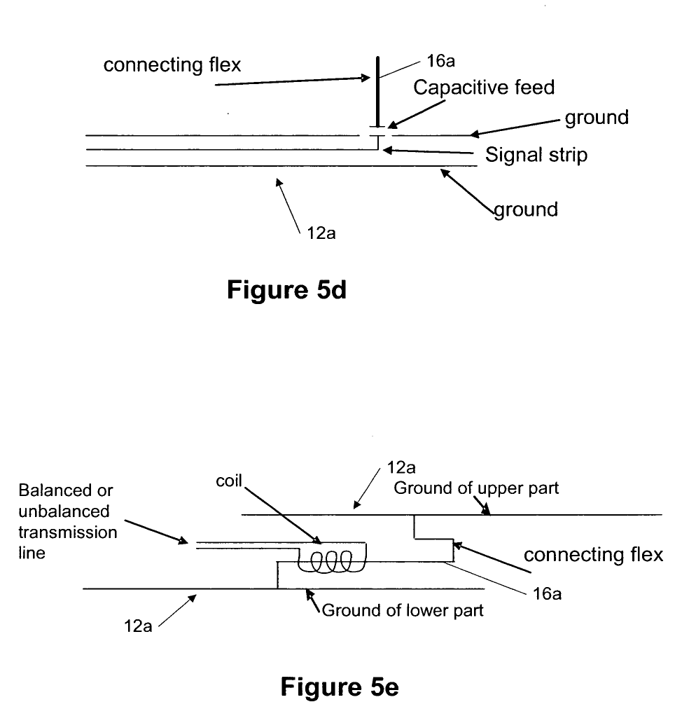

There are several ways to implement the connection 20a and/or 20b, according to further embodiments described herein. FIGS. 3a and 3b show examples among others of schematic representations of a feed arrangement in the first (low part) of the mobile terminal in a closed position (FIG. 3a) and in an open position (FIG. 3b) of a slide-type mobile terminal 10, according to an embodiment of the present invention. Here, the radiating element (e.g., PWB) 14a of the second part 14 is combined with the connecting flex 16 as one part as described herein, so only the feed connection 20a is needed to provide the RF signal to the radiating elements (e.g., PWBs) 12a and 14a. The feed connection 20a can be provided, as shown in FIGS. 3a and 3b, using a connector 30 between said connecting flexible electrically conducting strip 16a of the connecting flex 16 and the radiating element (e.g., PWB) 12a, as shown in FIGS. 3a and 3b. Also, the connector 30 may connect the conducting strips of the connecting flex 16 to the ground layers of the wiring boards and also connect other signal strips to their transmission lines inside the PWBs as shown, e.g., in FIGS. 2a and 2b. Different implementation scenarios for the feed arrangement are demonstrated in FIGS. 4 and 5a-5e.

The feed arrangement according to embodiments of the present invention, described herein, can be called dipole-like feeding or direct feeding. FIG. 4 shows an example among others of feed arrangement implementation in two-part terminals (e.g., slide-like terminals) in the first (lower) part of the mobile terminal using a feed pad with a stripline as described herein. In FIG. 4, the RF signal is transmitted from the transceiver to the antenna using a transmission line (stripline), which is connected to a feed pad (possibly inside the connector 30). The connecting flex 16a connecting the PWB's 12a and 14b of the two parts 12 and 14, respectively, is connected to the feed pad in the lower PWB 12a and at the other end to the ground of the upper PWB 14a, as shown. The PWBs or the flexible wiring boards and attached metal components of the two parts are called radiating elements (as opposed to the traditional antenna element).

The example of FIG. 4 represents a galvanic unbalanced feed arrangement using a stripline for connecting to the feed pad. Other feed arrangement of this type can use a coaxial cable arrangement (FIG. 5a) or a microstrip arrangement (FIG. 5b), wherein the RF signal is directly coupled to the conducting strip 16a of the connecting flex 16 but without connecting the conducting strip 16a to the ground (an RF ground) of the PWBs 12a. Alternatively a balanced feed arrangement can be deployed utilizing two strips, wherein one strip is connected to the ground of the lower PWB 12a and the other strip is connected to the conducting strip 16a (FIG. 5c). Also capacitive coupling (using capacitive feed) and inductive coupling (using coil arrangement) can be used as shown in FIGS. 5d and 5e respectively. In addition, in the inductive method, the connecting flex 16 could have a coil located next to the coil of the feeding transmission line 17, and the coils can be wound around a ferrite rod or wound inside each other. The coupling of a coil or a loop (or a multi-turn loop) to a connecting flex can be maximized by placing it in the maximum of the magnetic fields so that the magnetic field is perpendicular to the plane of the coil/loop. Also a balun can be used for the feed arrangement to control the currents in the two parts (low and upper parts), as a balun is typically used when a dipole antenna is fed by an unbalanced transmission line (e.g. a coaxial cable).

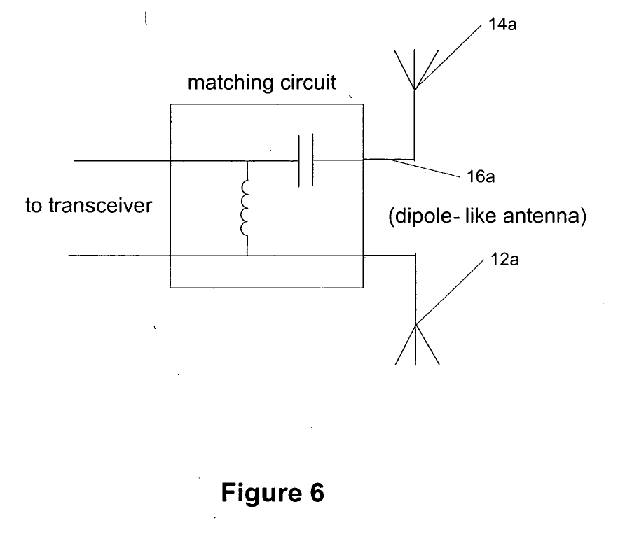

It is noted that the antenna feed e.g., the feed connection 20a can be followed by a matching circuit to better match the antenna input impedance to the characteristic impedance of the transmission line feeding the antenna. The role of the matching circuit is to change the impedance of the antenna to something that is close to the impedance of the transmission line in order to avoid reflections from impedance discontinuities. There could be a tunable or switchable matching circuit that could compensate for the changing impedances when the terminal device is closed. The matching circuit can be constructed of discrete components (e.g. capacitors, inductors, resistors) or sections of a transmission line. FIG. 6 shows a simple block diagram (one example among others) of the matching circuit, where an inductor and a capacitor are used. A real matching circuit may include more components in series or in parallel, combined with sections of the transmission line. For tunable or switchable matching circuits, switches, tunable capacitors, variable phase shifter and other tunable components can be used, as is known in the art. The components mentioned above can be based on or be manufactured using any known RF or microwave technology. At least one of the components can also be integrated to the flexible feed connection.

According to another embodiment of the present invention, an alternative approach for the feed connection 20a is to connect metallization on the connecting flex 16 directly to the PWB (printed wiring board) of the first part 12 at a feed point that is then connected to the RF engine through the signal lines inside the PWB. The critical point here is that the connecting flex 16 is not connected to the RF ground of the PWB of the first part 12.

It is noted that the antenna arrangement described herein may not require any extra space for the antenna, as the wiring boards of the first (lower) and second (upper) parts of the device are used as the radiating elements. The antenna arrangement can be very broadband when the slide-type mobile terminal (device) is in the open position. However, according to current knowledge, the current antenna arrangement might be quite narrowband when the slide-type mobile terminal is in the closed position. Also, it is noted that the mobile terminals might have a combination of traditional antennas and the antenna arrangement described in various embodiments herein.

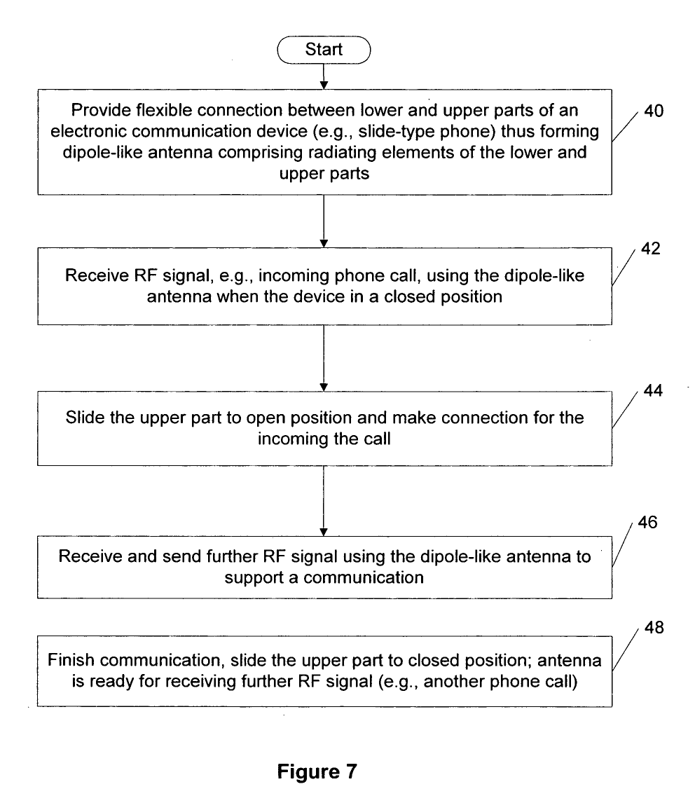

FIG. 7 is a flow chart illustrating application of the slide-type mobile terminal 10 comprising at least one connecting flex between lower and upper parts, according to a further embodiment of the present invention.

The flow chart of FIG. 7 only represents one possible scenario among others. The order of steps shown in FIG. 7 is not absolutely required, so generally, the various steps can be performed out of order. In a method according to an embodiment of the present invention, in a first step 40, a flexible connection between lower and upper parts of an electronic communication device (e.g., a slide-type phone) 10 is provided for forming a dipole-like antenna comprising radiating elements of the lower and upper parts, as described herein.

In a next step 42, an RF signal, e.g., incoming phone call or digital data transmit, is received by the device using the dipole-like antenna when the device is in a closed position. In a next step 44, the upper part is moved to an open position, and a connection for the incoming call is made. In a next step 46, a further RF signal supporting the communication is sent and received using the dipole-like antenna. In a next step 48, the communication is finished, and the upper part is moved back to a closed position; then the dipole-like antenna is ready for receiving the RF signals (e.g., another phone call).

It is further noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus, comprising:
a first part comprising a radiating element;
a second part comprising a further radiating element, wherein the first and second parts are configured to move relative to each other during operation; and
at least one connecting flex, for providing a flexible connection between said first and second parts, for providing a radio frequency signal between the radiating element and the further radiating element during said operation.

2. The apparatus of claim 1, said first and second parts are configured to slide relative to each other during said operation.

3. The apparatus of claim 1, wherein the radiating element and the further radiating element are printed wiring boards or flexible wiring boards.

4. The apparatus of claim 1, comprising at least one more connecting flex for providing a direct current power between the second and first parts.

5. The apparatus of claim 1, wherein said first part or said second part is combined with said at least one connecting flex as one part and said one part is made from a plastic flexible material.

6. The apparatus of claim 1, wherein said at least one connecting flex is made of a plastic flexible material and comprises at least one flexible electrically conducting strip.

7. The apparatus of claim 6, wherein said radio frequency signal is provided to the radiating element or to the further radiating element through said at least one flexible electrically conducting strip, wherein a feed arrangement for said radio frequency signal is provided to said at least one flexible electrically conducting strip using a feed pad on said first or second part.

8. The apparatus of claim 6, wherein said radio frequency signal is provided to the radiating element or to the further radiating element through said at least one flexible electrically conducting strip using a direct electrical connection between said at least one flexible electrically conducting strip and a printed wiring board of the first part or a further printed wiring board of the second part, respectively, but without connecting said at least one flexible electrically conducting strip to an RF ground of the printed wiring board or the further printed wiring board, respectively.

9. The apparatus of claim 6, wherein said at least one flexible electrically conducting strip is made of copper.

10. The apparatus of claim 1, wherein said at least one connecting flex or at least one further connecting flex is configured for providing between the second and first parts at least one of: a) a connection for a direct current power, b) a connection for grounding or short circuiting, and c) a connection for a further electrical signal.

11. The apparatus of claim 10, wherein said connection for said grounding or short circuiting comprises discrete components.

12. The apparatus of claim 1, wherein said radio frequency signal is provided to the radiating element or to the further radiating element through at least one flexible electrically conducting strip of said at least one connecting flex, wherein a feed arrangement for said radio frequency signal to said at least one flexible electrically conducting strip is provided on said first or second part using one of: a) galvanic feeding, b) capacitive feeding, and c) inductive feeding.

13. The apparatus of claim 11, wherein said feed arrangement further comprises a matching circuit.

14. The apparatus of claim 11, wherein said feed arrangement further comprises a balun.

15. The apparatus of claim 1, wherein said apparatus is for wireless communications in cellular or non-cellular systems.

16. The apparatus of claim 1, wherein said apparatus is part of or implemented as a mobile terminal, a portable communication device, a wireless device, a mobile communication device, a mobile phone or a mobile device for wireless communications in cellular or non-cellular systems.

17. A method, comprising:
providing a flexible connection between a first part and a second part of an electronic device, wherein the first part comprises a radiating element and the second part comprises a further radiating element, and the first part and the second part are configured to move relative to each other during operation of said electronic device; and
providing a radio frequency signal between the radiating element and the further radiating element during said operation.

18. The method of claim 17, said first and second parts are configured to slide relative to each other during said operation.

19. The method of claim 17, wherein the radiating element and the further radiating element are printed wiring boards or flexible wiring boards.

20. The method of claim 17, comprising at least one more connecting flex for providing a direct current power between the second and first parts.

21. The method of claim 17, wherein said first part or said second part is combined with said at least one connecting flex as one part and said one part is made from a plastic flexible material.

22. The method of claim 17, wherein said at least one connecting flex is made of a plastic flexible material and comprises at least one flexible electrically conducting strip.

23. The method of claim 22, wherein said radio frequency signal is provided to the radiating element or to the further radiating element through said at least one flexible electrically conducting strip, wherein a feed arrangement for said radio frequency signal is provided to said at least one flexible electrically conducting strip using a feed pad on said first or second part.

24. The method of claim 22, wherein said radio frequency signal is provided to the radiating element or to the further radiating element through said at least one flexible electrically conducting strip using a direct electrical connection between said at least one flexible electrically conducting strip and a printed wiring board of the first part or a further printed wiring board of the second part, respectively, but without connecting said at least one flexible electrically conducting strip to an RF ground of the printed wiring board or the further printed wiring board, respectively.

25. The method of claim 22, wherein said at least one flexible electrically conducting strip is made of copper.

26. The method of claim 17, wherein said electronic device is a mobile terminal, a portable communication device, a wireless device, a mobile communication device, a mobile phone or a mobile device for wireless communications in cellular or non-cellular systems.

27. An apparatus, comprising:
a first part comprising a radiating element;
a second part comprising a further radiating element, wherein the first and second parts are configured to move relative to each other during operation; and
at least one connecting means, for providing a flexible connection between said first and second parts, for providing a radio frequency signal between the radiating element and the further radiating element during said operation.

28. The apparatus of claim 27, wherein said at least one connecting means is at least one connecting flex made from a plastic flexible material.
